(19) United States
(12) Patent Application Publication
(10) Pub. No.: US 2011/0127217 A1
(43) Pub. Date: Jun. 2, 2011

(54) OIL SANDS PROCESS WATER TREATMENT FOR REUSE

(75) Inventors: GAIL BUCHANAN, Fort McMurray (CA); WARREN ZUBOT, Edmonton (CA)

(73) Assignee: SYNCRUDE CANADA LTD. in trust for the owners of the Syncrude Project, Fort McMurray (CA)

(21) Appl. No.: 12/938,198

(22) Filed: Nov. 2, 2010

Related U.S. Application Data
(60) Provisional application No. 61/257,778, filed on Nov. 3, 2009.

(51) Int. Cl. C02F 9/02; C02F 1/44; C02F 1/40; C02F 1/28

(52) U.S. Cl. 210/638; 210/641

(57) ABSTRACT

A process for treating oil sands process water is provided, comprising removing free oil and grease from the oil sands process water to produce de-oiled process water; reducing the total suspended solids by subjecting the de-oiled process water to filtration using a membrane system to produce filtered process water; and removing dissolved ions such as chloride ions and sulfate ions present in the filtered process water by reverse osmosis to produce a treated water stream and a concentrated salt stream.

This application claims the benefit of U.S. Provisional Application No. 61/257,778, filed Nov. 3, 2009.

### FIELD OF THE INVENTION

The present invention relates generally to Recycle Water treatment and, in particular, to a method for treating oil sands process water (OSPW) for reuse in an integrated oil sands operation, specifically to back out raw water import from the Athabasca River).

### BACKGROUND OF THE INVENTION

For the past 25 years, the bitumen in Athabasca oil sand has been commercially recovered using a hot water-based extraction process. In the first step of this process, the oil sand is slurried with hot process water, naturally entrained air and, optionally, caustic (NaOH). The slurry is mixed, for example in a tumbler or pipeline, for a prescribed period of time, to initiate a preliminary separation or dispersal of the bitumen and solids and to induce air bubbles to contact and aerate the bitumen. This step is referred to as “conditioning”.

The conditioned slurry is then further diluted with flood water and introduced into a large, open-topped, conical-bottomed, cylindrical vessel (termed a primary separation vessel or “PSV”). The diluted slurry is retained in the PSV under quiescent conditions for a prescribed retention period. During this period, aerated bitumen droplets rise and form a bitumen froth layer, which continuously overflows the top lip of the vessel and is collected away in a launder. Heavier sand grains sink and are concentrated in the conical bottom together with the water. They leave the bottom of the vessel as a wet tailings stream containing a small amount of bitumen. Middlings, a watery mixture containing solids and bitumen, extend between the froth and sand layers.

The wet tailings and middlings are separately withdrawn, combined and sent to a secondary flotation process. This secondary flotation process is commonly carried out in a deep cone vessel wherein air is sparged into the vessel to assist with flotation. This vessel is referred to as the TOR vessel. The bitumen recovered by flotation in the TOR vessel is recycled to the PSV. The middlings from the deep cone vessel are further processed in induced air flotation cells to recover contained bitumen.

The froths produced by the PSV and flotation cells are then combined and subjected to further froth cleaning, i.e., removal of entrained water and solids, prior to upgrading. Typically, bitumen froth comprises about 60% bitumen, 30% solids and 10% water. There are currently two commercially proven processes to clean bitumen froth. One process involves dilution of the bitumen froth with a naphtha solvent, followed by bitumen separation in a sequence of scroll and disc centrifuges. Alternatively, the naphtha diluted bitumen may be subjected to gravity separation in a series of inclined plate separators (“IPS”) in conjunction with countercurrent solvent extraction using added naphtha, or some combination of both.

All of these steps in water extraction of bitumen from oil sands require a substantial amount of water, over 80 percent of which is recycled OSPW from the tailings ponds. Over 75 percent of the raw water currently diverted from the Athabasca River is used as Cooling Tower and Water Treatment Plant make-up. While much of the water used is recycled from oil sand tailings pond, the continuous recycling and reuse of OSPW results in a degradation of the quality of the water, for example, an increase in salinity and sulfate concentrations. Reduced quality of water not only results in increases in operating and maintenance costs, the increase in salinity and sulfates may impact the overall extraction process and bitumen recovery. Furthermore, there is a current trend for oil sand companies to reduce the tailings pond footprint.

However, the main business need for treating OSPW is to reduce the risk of a potential bitumen production restriction due to limitations in on-site water storage capacity at plant sites. For example, one factor that may contribute to a tailings fluids model “bust” is the need to import additional raw water (i.e., 5-10 Mm³/yr) as “flush” water. The treatment of OSPW to raw water quality, to back out an equivalent amount of raw water import from the river, can help reduce the risk of a bitumen production limiting event.

### SUMMARY OF THE INVENTION

Broadly stated, in one aspect of the invention, a process is provided for treating oil sands process water (OSPW), for example, Recycle Water from tailings ponds, which is suitable for reuse as process water in oil sand water extraction processes. More particularly, a process for treating oil sands process water is provided, comprising:
removing free oil and grease from the oil sands process water;
reducing the total suspended solids (TSS) by subjecting the de-oiled process water to filtration using a membrane system; and
removing dissolved ions such as chloride ions and sulfate ions present in the filtered process water by reverse osmosis to produce a treated water stream and a concentrated salt stream.

In one embodiment, oil and grease is removed from the oil sand process water in an oil-water separator. In another embodiment, oil and grease is removed from the process water in an induced air flotation oil-water separator (induced air flotation). In another embodiment, oil and grease is removed from the process water in a dissolved air flotation device.

In one embodiment, microfiltration and/or ultrafiltration is used to reduce TSS using polymeric membranes, ceramic membranes and the like. Examples of membranes which could be used to reduce TSS are Zenon ZeeWeed™ Ultra-filtration (UF) membranes and V*SEP membranes. In addition to reducing TSS, membranes of the present invention can also remove additional organic carbons still present in the water.

In one embodiment, the dissolved ions such as chloride ions and sulfate ions are removed from the filtered water by reverse osmosis filtration using a reverse osmosis membrane (e.g., a V*SEP membrane). In another embodiment, the filtered process water is subjected to an advanced oxidation step, such as ozonation, and/or absorption using activated carbon (charcoal) to remove organics such as naphthenic acids prior to removing the dissolved ions such as chloride ions and sulfate ions.

In one embodiment, the concentrated salt stream produced during ultrafiltration and reverse osmosis is first evaporated and then crystallized to produce solids that can be disposed of either in on-site or off-site landfill disposal sites.

### DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIG. 1 is a schematic showing one embodiment of the process of the present invention.

FIG. 2 is a photograph showing recycle cooling water from tailings ponds (labeled RCW) that has been spiked with 1000 ppm bitumen before and after ceramic membrane filtration.

FIG. 3 is a bar graph showing the composition of recycle water, bitumen-spiked recycle water and permeate after ceramic membrane filtration using membranes having a membrane pore size of 0.01 micrometers (μm) for Ultrafiltration (UF) and 0.1 micrometers (μm) for Microfiltration (MF).

### DESCRIPTION OF THE PREFERRED EMBODIMENT

The detailed description set forth below in connection with the appended drawing is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

In one aspect, the invention is concerned with a process for treating oil sand process water, for example, water recycled from oil sand tailings ponds.

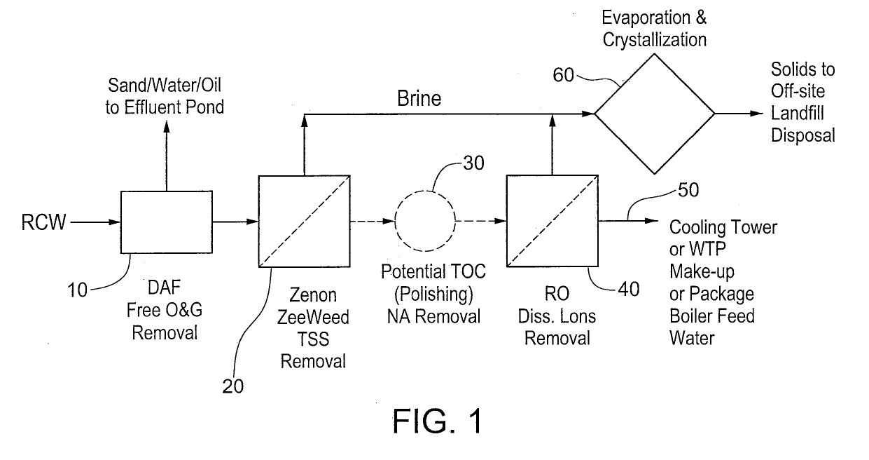

With reference now to FIG. 1, recycled water from tailings ponds (also referred to as recycle cooling water or RCW), or process water from any step in the oil sand extraction process, is first treated by dissolved air flotation in a dissolved air flotation device 10, where the free oil and grease floats to the top of the device 10 and any sand present settles to the bottom. The de-oiled water is then subjected to ultrafiltration 20, for example, using polymeric ultrafiltration membranes such as Zenon ZeeWeed™ or CeraMem® Crossflow microfiltration (0.01 micrometers)/ultrafiltration (0.01 micrometers) ceramic membranes, for removal of suspended solids, such as smaller sand grains and clays, and larger organic carbons and naphthenic acids.

The filtered water can then optionally be further treated (via device 30) to remove any remaining smaller organics or naphthenic acids, for example, by ozonation or absorption of the organics using activated charcoal and the like. The polished water can then be subjected to reverse osmosis (via device 40) to remove any dissolved monovalent ions such as chloride ions. Technologies employing Reverse Osmosis Membrane systems, such as the V*SEP membrane system (polymeric membrane system) or CeraMem® ceramic membrane systems can be used. The treated process water can then be recycled and re-used to displace raw water as cooling tower make-up, Water Treatment Plant (WTP) make-up or package boiler feed water (BFW), as well as any other oil sand processing step.

The brine, i.e., concentrated water and salts streams (concentrate) from both the ultrafiltration and/or microfiltration step 20 and the reverse osmosis step 40, can be further treated by evaporation and crystallization 60 so that the solids can be disposed of in an off-site or on-site landfill.

### EXAMPLE 1

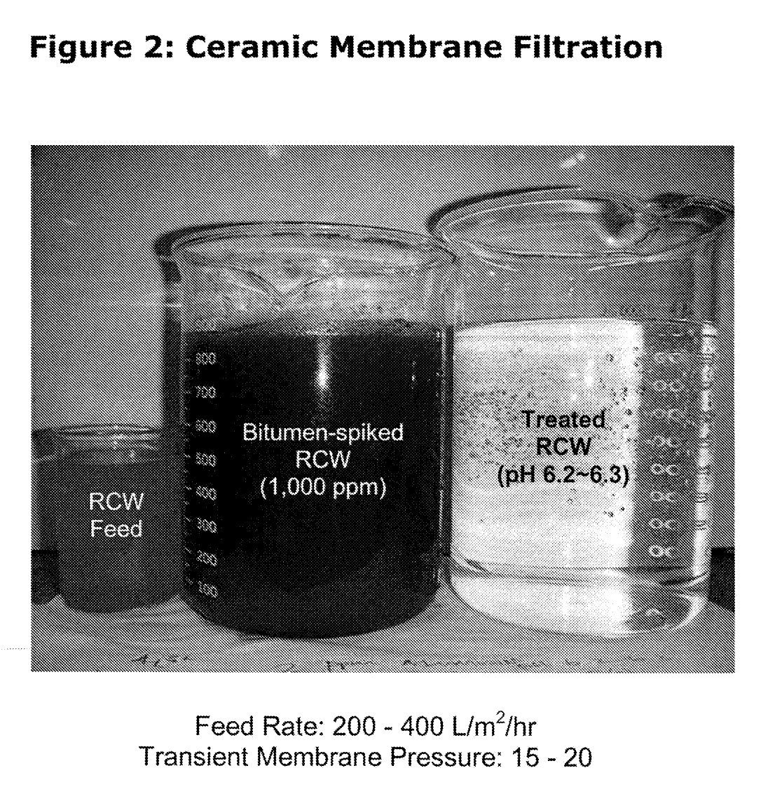

Oil sands process water from oil sand tailings pond, or recycle water or RCW, was spiked with 1,000 ppm bitumen to simulate an extreme oil sands process water supply. The bitumen-spiked RCW was then subjected to ceramic membrane filtration by passing the RCW through a 100 nm (i.e., 0.1 micrometer) pore size ceramic membrane at a feed rate of between about 200 to about 400 liters/m²/hr. The transient membrane pressure was maintained at between about 15 to about 20 psi. FIG. 2 is a photograph showing RCW feed, bitumen-spiked RCW and ceramic membrane filtered or treated RCW. The pH of the treated RCW was approximately 6.2 to 6.3.

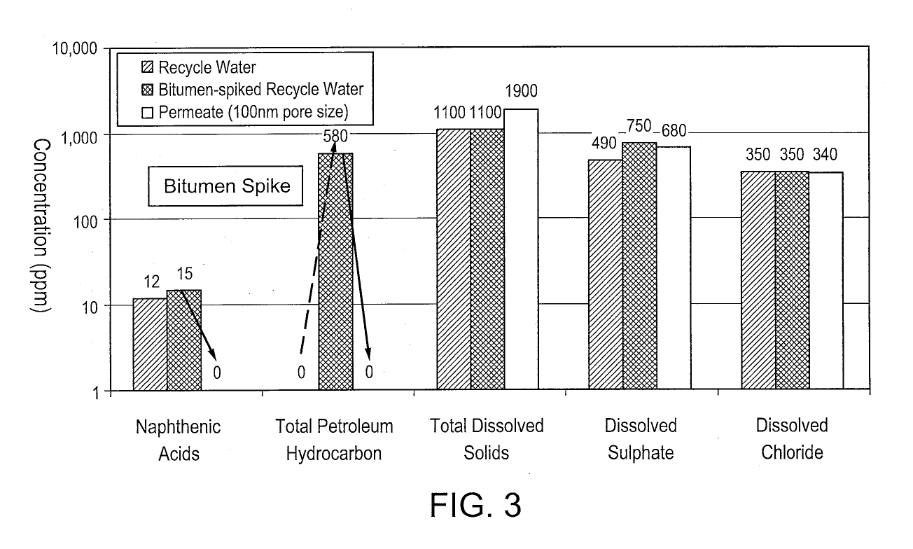

FIG. 3 shows that ceramic membrane filtration of bitumen-spiked recycle water results in a reduction to essentially zero ppm of both naphthenic acids and total petroleum hydrocarbon.

From the foregoing description, one skilled in the art can easily ascertain the essential characteristics of this invention, and without departing from the spirit and scope thereof, can make various changes and modifications of the invention to adapt it to various usages and conditions. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

What is claimed:

1. A process for treating oil sands process water, comprising:
removing free oil and grease from the oil sands process water to produce de-oiled process water;
reducing the total suspended solids by subjecting the de-oiled process water to filtration using a membrane system to produce filtered process water; and
removing dissolved ions such as chloride ions and sulfate ions present in the filtered process water by reverse osmosis to produce a treated water stream and a concentrated salt stream.

2. The process as claimed in claim 1 wherein the oil and grease is removed from the oil sand process water in an oil-water separator.

3. The process as claimed in claim 1 wherein the oil and grease is removed from the process water in an induced air flotation oil-water separator.

4. The process as claimed in claim 1 wherein the oil and grease is removed from the process water in a dissolved air flotation device.

5. The process as claimed in claim 1 wherein the total suspended solids is reduced by microfiltration and/or ultrafiltration using polymeric membranes, ceramic membranes and the like.

6. The process as claimed in claim 5 wherein the membrane used to reduce the total suspended solids are Zenon ZeeWeed™ Ultra-filtration membranes or V*SEP membranes.

7. The process as claimed in claim 1 wherein in addition to reducing the total suspended solids, the membranes remove additional organic carbons still present in the de-oiled process water.

8. The process as claimed in claim 1 wherein the dissolved ions such as chloride ions and sulfate ions are removed from the filtered water by reverse osmosis filtration using a reverse osmosis membrane.

9. The process as claimed in claim 1 further comprising:
subjecting the filtered process water to an advanced oxidation step to remove organics such as naphthenic acids prior to removing the dissolved ions such as chloride ions and sulfate ions.

10. The process as claimed in claim 9 wherein the advanced oxidation step is either ozonation, absorption using activated carbon, or both.

11. The process as claimed in claim 1 further comprising:
evaporating and crystallizing the concentrated salt stream to produce solids that can be disposed of either in an on-site or an off-site landfill disposal site.

12. The process as claimed in claim 1 wherein the treated water is used as cooling tower water.

13. The process as claimed in claim 1 wherein the treated water is used as package boiler feed water.
